(19) United States
(12) Patent Application Publication
(10) Pub. No.: US 2008/0078754 A1
(43) Pub. Date: Apr. 3, 2008

(54) Method of welding aluminum alloy steels

(76) Inventors: Peter Hosemann, Los Alamos, NM (US); Franz-Xaver Mayer, Krankanbaus (DE)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 11/540,190

(22) Filed: Sep. 28, 2006

(51) Int. Cl. B23K 9/23

(52) U.S. Cl. 219/137 WM

(57) ABSTRACT

A method of welding aluminum alloy steel, and oxide dispersion strengthened aluminum alloy steel. The method includes heating at least one aluminum alloy steel work piece to a predetermined temperature, cleaning the weld surface, providing an Aluchrom Y filler to the weld site, welding the work piece and filler under an argon atmosphere to form a welded article, and post-weld heat treating the welded article. The method may also be used to join aluminum alloy steels to austenitic steels. A welded article joined by the method is also described.

### STATEMENT REGARDING FEDERAL RIGHTS

This invention was made with government support under Contract No. DE-AC 52-06 NA 25396, awarded by the U.S. Department of Energy. The government has certain rights in the invention.

### BACKGROUND OF INVENTION

The invention relates to welding steels. More particularly, the invention relates to a method of welding oxide dispersion strengthened steels. Even more particularly, the invention relates to a welded article that is joined using such a method.

Aluminum alloy steels—particularly oxide dispersion strengthened steels—are used in applications where high temperature strength is of importance. For example, such steels are used in pipes and other containment structures for highly corrosive materials such as liquid metals under high temperature-high pressure conditions in power generation applications.

Due to their complex compositions, one problem encountered during the use of such steels is the inability to weld such steels using regular steel welding techniques. The use of steel fillers such as 316L typically results in the formation of a brittle weld and cracking of the welded article. Joining such steels is currently accomplished using friction stir welding, which, due to its complexity, generally precludes on site use.

Current methods of welding aluminum alloy steels are not portable and produce a joint that is susceptible to different modes of failure. Therefore what is needed is a method of welding aluminum alloy steels that is adaptable to welding such work pieces on site rather than in a workshop. What is also needed is a method of welding aluminum alloy steel that forms a ductile joint and retains a substantial amount of strength.

### SUMMARY OF INVENTION

The present invention meets these and other needs by providing a method of welding aluminum alloy steel, and oxide dispersion strengthened aluminum alloy steel. The method includes heating at least one aluminum alloy steel work piece to a predetermined temperature, cleaning the weld surface, providing an Aluchrom Y filler to the weld site, welding the work piece and filler under an argon atmosphere to form a welded article, and post-weld heat treating the welded article. The method may also be used to join aluminum alloy steels to austenitic steels. A welded article joined by the method is also described.

Accordingly, one aspect of the invention is to provide a method of welding aluminum alloy steel. The method comprises the steps of: providing at least one work piece, wherein the at least one work piece comprises an aluminum alloy steel; preparing a weld surface on the at least one work piece; preheating the weld surface at a first predetermined temperature; providing a filler material to the weld surface, wherein the filler material comprises about 5 weight percent aluminum; about 20 weight percent chromium; about 0.1 weight percent yttrium, and iron; welding the at least one work piece and the filler material in an argon atmosphere to form a welded article; and post-heating the welded article at a second predetermined temperature.

A second aspect of the invention is to provide a filler material for welding at least one work piece, wherein the filler material comprising about 5 weight percent aluminum; about 20 weight percent chromium; about 0.1 weight percent yttrium, and a balance of iron.

A third aspect of the invention is to provide a method of welding aluminum alloy steel. The method comprises the steps of: providing at least one work piece, wherein the at least one work piece comprises an aluminum alloy steel; preparing a weld surface on the at least one work piece; preheating the weld surface at a first predetermined temperature; providing a filler material to the weld surface, wherein the filler material comprises about 5 weight percent aluminum; about 20 weight percent chromium; about 0.1 weight percent yttrium, and a balance of iron; welding the at least one work piece and the filler material in an argon atmosphere using tungsten inert gas welding to form a welded article, wherein the tungsten inert gas welding is carried out in one of an AC pulse mode and a DC pulse mode; and post-heating the welded article at a second predetermined temperature.

A fourth aspect of the invention is to provide a welded article. The welded article comprises at least one work piece having a weld, wher welded article comproses at least one work piece having a weld, wherein the at least one work piece comprises an aluminum alloy steel. The weld is formed by: providing the at least one work piece; preparing a weld surface on the at least one work piece; preheating the weld surface at a first predetermined temperature; providing a filler material to the weld surface, wherein the filler material comprises about 5 weight percent aluminum; about 20 weight percent chromium; about 0.1 weight percent yttrium, and a balance of iron; welding the at least one work piece and the filler material in an argon atmosphere to form the welded article; and post-heating the welded article at a second predetermined temperature.

These and other aspects, advantages, and salient features of the present invention will become apparent from the following detailed description, the accompanying drawings, and the appended claims.

### BRIEF DESCRIPTION OF THE DRAWINGS

FIG. 1 is a schematic representation of a welded article;

FIG. 2 is a flow chart for a method of welding an aluminum alloy steel;

FIG. 3a is a micrograph of a weld formed using standard DC tungsten inert gas (TIG) welding;

FIG. 3b is a micrograph of a weld formed using standard AC TIG welding;

FIG. 3c is a micrograph of a weld formed using AC pulsed TIG welding;

FIG. 4a is a micrograph of a weld comprising MA956 welded to 316L steel using 316L filler;

FIG. 4b is a plot of microhardness as a function of weld distance for the weld shown in FIG. 4a; and

FIG. 5a is a micrograph of a weld comprising MA956 welded to 316L steel using Aluchrome Y filler; and

FIG. 5b is a plot of microhardness as a function of weld distance for the weld shown in FIG. 5a.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. In addition, whenever a group is described as either comprising or consisting of at least one of a group of elements and combinations thereof, it is understood that the group may comprise or consist of any number of those elements recited, either individually or in combination with each other.

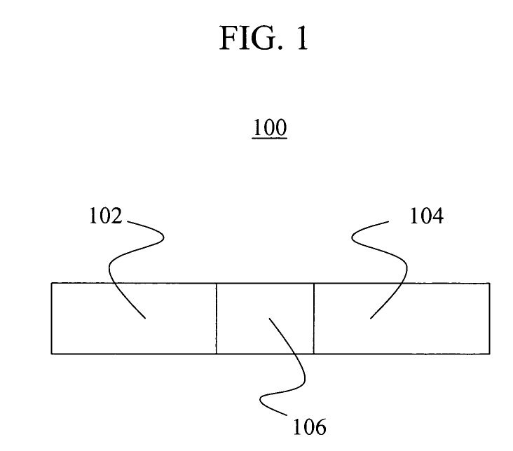

Referring to the drawings in general and to FIG. 1 in particular, it will be understood that the illustrations are for the purpose of describing a particular embodiment of the invention and are not intended to limit the invention thereto. Turning to FIG. 1, a welded article is schematically shown. Welded article 100 comprises at least one work piece. In the embodiment shown in FIG. 1, welded article 100 includes a first work piece 102 and a second work piece 104 joined by weld 106. Alternatively, the welded article may comprise a single work piece, such as, for example, a pipe or sheet having a gap of flaw that may be repaired by welding.

At least one of first work piece 102 and second work piece 104 comprises an aluminum alloy steel. In one embodiment, the aluminum alloy steel is an oxide dispersion strengthened steel (also referred to herein as “ODS”) comprising from about 4.5 wt % to about 5.5 wt % aluminum, about 20 wt % chromium, about 0.5 wt % yttria (Y₂O₃), with the balance being iron. Such ODS steels include, but are not limited to, MA956™ (4.5 wt % Al; 20 wt % Cr; 0.5 wt % Y₂O₃; with the balance being Fe), PM2000™ (5.5 wt % Al; 20 wt % Cr; 0.5 wt % Y₂O₃; with the balance being Fe), and combinations thereof.

In another embodiment, second work piece 104 may comprise an austenitic steel having a composition of up to about 0.8 wt % carbon, from about 16 to about 20 wt % chromium, from about 8 to about 14 wt % nickel, less than about 3 wt % molybdenum, less than about 2 wt % manganese, less than about 1 wt % silicon, less than 0.0045 wt % phosphorus, and less than about 0.03 wt % sulfur, with the balance being iron. Such austenitic steels include, but are not limited to 316 or 316L (<0.03 wt % C, 16-18.5 wt % Cr, 10-14 wt % Ni, 2-3% Mo, <2 wt % Mn, <1 wt % Si, <0.045 wt % P, <0.03 wt % S, balance Fe) and 304 (<0.08 wt % C, 17.5-20 wt % Cr, 8-11 wt % Ni, <2 wt % Mn, <1 wt % Si, <0.045 wt % P, <0.03 wt % S, balance Fe) stainless steels, combinations thereof, and the like.

Weld 106 comprises Aluchrom Y™ (5 wt % Al;20 wt % Cr; 0.1 wt % Y, balance Fe) filler material. In order to facilitate filling the weld, the filler material is typically provided in the form of a wire or rod.

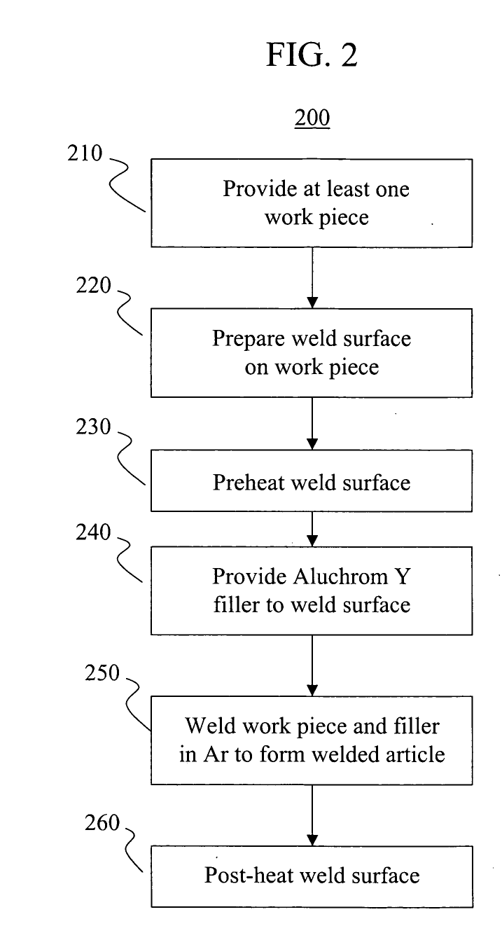

A method of welding aluminum alloy steel is provided. A flow chart outlining method 200 is shown in FIG. 2. In Step 210, at least one work piece comprising an aluminum alloy steel is provided. A weld surface—the surface of the at least one work piece at which the welding is to be done—is prepared in Step 220. Here, the surfaces and areas of the at least one work piece 102, 104 that are to be welded are cleaned—i.e., oxides, oil, dirt, and other contaminants are removed. Cleaning may be performed under ambient conditions just before welding the at least one work piece, as the time between cleaning and welding is too brief for any substantial amount of oxide to form on the weld surface. Step 220 may, however, be carried out in vacuum if desired. Step 220 may include abrasive cleaning of the weld surface using means for removing metal oxide that are well known in the art, such as sanding (blasting or with sandpaper), wire brushing, and the like.

In Step 230, the weld surface is preheated at a predetermined temperature. The predetermined temperature is in a range from about 300° C. to about 350° C. During preheating and welding, the weld surface is maintained at a temperature of at least 300° C. Step 230 may be carried out using resistance heaters, such as a round WITLOW™ heater, that are known in the art. Such transportable heaters facilitate the preheating and maintenance of the weld surface temperature on work pieces. For example, such transportable heaters may be used to preheat pipes at a construction site.

Aluchrom Y™ filler material is then provided to the weld surface (Step 240). The Aluchrom Y filler material is typically provided as a wire or rod to facilitate filling the weld. If the temperature is not maintained at this temperature, cracks may develop in the at least one work piece.

In Step 250 the Aluchrom Y filler material and the at least one work piece are welded in an argon atmosphere to form the weld and the welded article. The entire weld site (i.e., the weld surface and Aluchrom Y filler material) is covered—i.e., “blanketed”—with argon. Several methods of ensuring that the weld site is adequately covered with argon are known in the art. The use of an external sleeve, for example, when welding pipe not only secures the pipe sections to be joined but also focuses the argon gas flow on the weld site and ensures that argon stays inside the pipe during the welding process.

Welding in Step 250 is preferably carried out using tungsten inert gas (also referred to herein as “TIG”) welding. In one particular embodiment, AC TIG welding, pulsed at 80 amperes for 0.4 seconds and at 20 Amperes for 0.6 seconds (80/20/0.4/0.6), is used. In another embodiment, DC pulsed TIG welding is used. Other welding methods, such as, but not limited to, electron beam welding, laser welding, and friction stir welding may be used as well.

Immediately after welding, the welded article undergoes a post-heat treatment in Step 260 at a predetermined temperature. The predetermined temperature may be in a range from about 700° C. to about 800° C. In one embodiment, the post-heat temperature is at least 750° C. The welded article is held at the post-heat temperature for at least one hour. Following the post-heat treatment, the welded article is furnace cooled at a predetermined rate, with slower cooling rates being preferred. In one embodiment, the welded article is furnace cooled at a rate of up to about 1° C./minute.

The following examples illustrate the advantages and features of the invention and are in no way intended to limit the invention thereto.

### EXAMPLE 1

### MA956-MA956 Welds

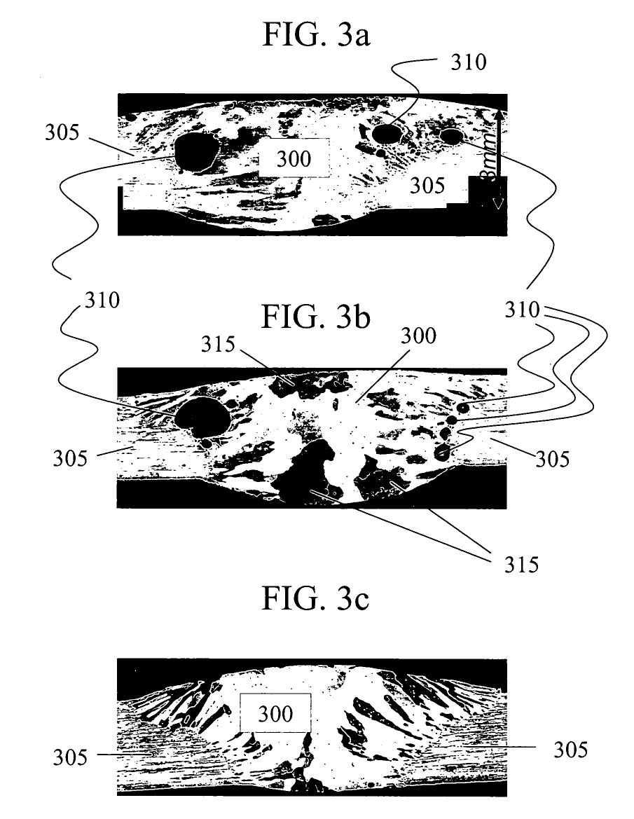

In separate experiments, two pieces of MA956 pipe (305 in FIGS, 3a, 3b, 3c) were welded together under an argon atmosphere using Aluchrome Y filler and either standard DC TIG, standard AC TIG, or AC pulsed TIG welding. Otherwise, the parameters for weld surface preparation, pre-heating, and post-heating were within the ranges previously described herein. The standard DC and standard AC TIG welds each required two passes, whereas the AC pulsed TIG welding required a single pass. Micrographs of the welds 300 that were obtained using each type of welding are shown in FIGS. 3a (standard DC TIG), 3b (standard AC TIG), and 3c (AC pulsed TIG). Standard (i.e., not pulsed) DC (FIG. 3a) and AC TIG welding of MA956 (FIG. 3b) produce welds having large pores 310 and large grain structures 315. In contrast to the welds obtained using standard DC and AC TIG welding, AC pulsed TIG welding of MA956 (FIG. 3c) results in a weld 300 that has no large-scale pores and smaller grains.

Tensile tests were performed on each of the welds. For this, the welded pipes were cut into strips 10 mm wide and 250 mm long. The tests showed that the strength of the welds are between about 65% and about 85% of the strength of un-welded MA956 at room temperature. The fracture was brittle and trans-granular, occurring exactly in the center of each of the welds, indicating the absence of a weak heat influence zone at each of the welds.

### EXAMPLE 2

### MA956-316L Welds

In one experiment, a MA956 piece was welded to a 316L piece under an argon atmosphere using 316L filler and DC pulsed TIG welding with two passes. In a second experiment, a MA956 piece was welded to a 316L piece under an argon atmosphere using Aluchrome Y filler and DC pulsed TIG welding with two passes. The parameters for weld surface preparation, pre-heating, and post-heating were within the ranges previously described herein.

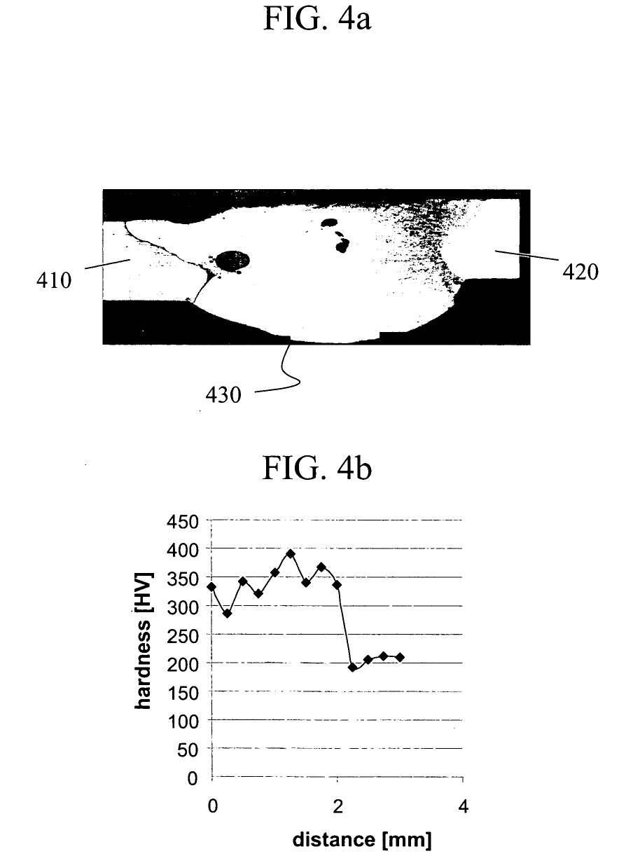

The results of cross section analyses of the weld using 316L filler are shown in FIGS. 4a and 4b. The weld 430 (FIG. 4a) between the MA956 piece 410 and the 316L piece 420 made using the 316L filler has a very hard and brittle structure, as evidenced by the plot of microhardness versus weld distance shown in FIG. 4b.

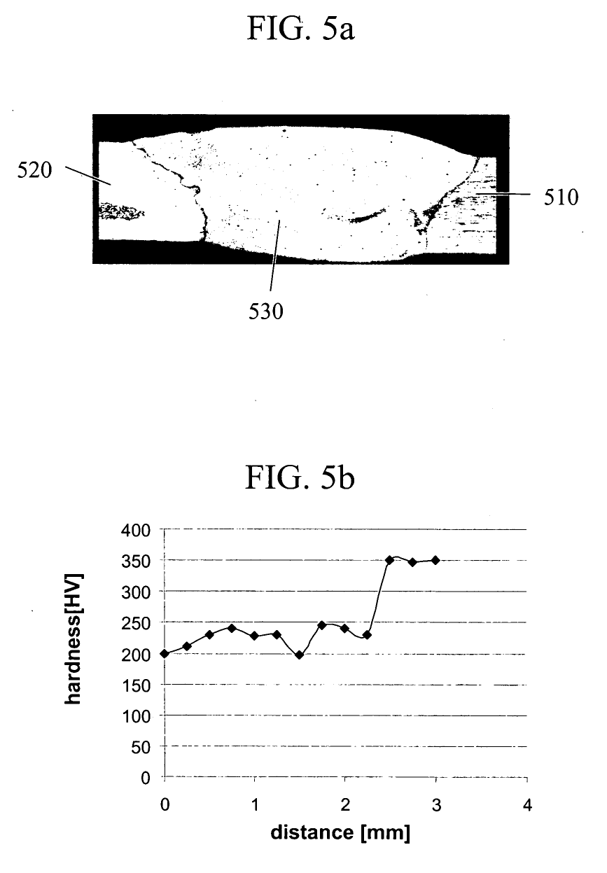

The results of cross section analyses of the weld made using the Aluchrome Y wire filler are shown in FIGS. 5a and 5b. The weld 530 (FIG. 5a) between the MA956 piece 510 and the 316L piece 520 made using the Aluchrome Y wire filler has a soft structure that increases the ductility of the weld. The behaviors of the two welds are based on the fact that the liquid metal generated during welding forms a new alloy in the weld, whereas use of the 316L filler forms a brittle martensitic material.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A method of welding an aluminum alloy steel, the method comprising the steps of:
a. providing at least one work piece, wherein the at least one work piece comprises an aluminum alloy steel;
b. preparing a weld surface on the at least one work piece;
c. preheating the weld surface at a first predetermined temperature;
d. providing a filler material to the weld surface, wherein the filler material comprises about 5 weight percent aluminum; about 20 weight percent chromium; about 0.1 weight percent yttrium, and iron;
e. welding the at least one work piece and the filler material in an argon atmosphere to form a welded article; and
f. post-heating the welded article at a second predetermined temperature.

2. The method according to claim 1, wherein the step of welding the work piece in an argon atmosphere to form a weld comprises welding the work piece in an argon atmosphere using tungsten inert gas welding to form a weld.

3. The method according to claim 2, wherein welding the work piece in an argon atmosphere to form a weld using tungsten inert gas welding further comprises welding the work piece using one of AC pulsed mode tungsten inert gas welding and DC pulsed mode tungsten inert gas welding.

4. The method according to claim 1, wherein the aluminum alloy steel work piece is an oxide dispersion strengthened steel.

5. The method according to claim 4, wherein the oxide dispersion strengthened steel comprises from about 4.5 weight percent to about 5.5 weight percent aluminum, about 20 weight percent chromium, 0.5 weight percent yttria, and a balance of iron.

6. The method according to claim 1, wherein the step of preparing the weld surface of the at least one work piece comprises removing a surface oxide from the weld surface.

7. The method according to claim 1, wherein the step of preheating the weld surface at a first predetermined temperature comprises heating the weld surface at a temperature in a range from about 300° C. to about 350° C.

8. The method according to claim 1, wherein the step of welding the at least one work piece further comprises maintaining the weld at a temperature of at least 300° C.

9. The method according to claim 1 wherein the step of post-heating the weld at a second predetermined temperature comprises post-heating the weld at a temperature in a range form about 700° C. to about 800° C.

10. The method according to claim 1, wherein the at least one work piece includes a first work piece comprising an aluminum alloy steel and a second work piece comprising an austenitic steel.

11. The method according to claim 10, wherein the step of welding the at least one work piece in an argon atmosphere to form a weld comprises welding the first work piece to the second work piece.

12. The method according to claim 10, wherein the austenitic steel comprises up to about 0.8 weight percent carbon, from about 16 to about 20 weight percent chromium, from about 8 to about 14 weight percent nickel, less than about 3 weight percent molybdenum, less than about weight percent manganese, less than about 1 weight percent silicon, less than 0.0045 weight percent phosphorus, less than about 0.03 weight percent sulfur, and a balance of iron.

13. The method according to claim 1, wherein the step of welding the at least one work piece in an argon atmosphere to form a weld comprises welding the work piece in an argon atmosphere using one of electron beam welding, laser welding, and friction stir welding to form a weld.

14. A filler material for welding at least one work piece, wherein the filler material comprising about 5 weight percent aluminum; about 20 weight percent chromium; about 0.1 weight percent yttrium, and a balance of iron.

15. A method of welding an aluminum alloy steel, the method comprising the steps of:
a. providing at least one work piece, wherein the at least one work piece comprises an aluminum alloy steel;
b. preparing a weld surface on the at least one work piece;
c. preheating the weld surface at a first predetermined temperature;
d. providing a filler material to the weld surface, wherein the filler material comprises about 5 weight percent aluminum; about 20 weight percent chromium; about 0.1 weight percent yttrium, and a balance of iron;
e. welding the at least one work piece and the filler material in an argon atmosphere using tungsten inert gas welding to form a welded article, wherein the tungsten inert gas welding is carried out in one of an AC pulse mode and a DC pulse mode; and
f. post-heating the welded article at a second preheated temperature.

16. A welded article, the welded article comprising at least one work piece having a weld, wherein the at least one work piece comprises an aluminum alloy steel, wherein the weld is formed by:
a. providing the at least one work piece;
b. preparing a weld surface on the at least one work piece;
c. preheating the weld surface at a first predetermined temperature;
d. providing a filler material to the weld surface, wherein the filler material comprises about 5 weight percent aluminum; about 20 weight percent chromium; about 0.1 weight percent yttrium, and iron;
e. welding the at least one work piece and the filler material in an argon atmosphere to form the welded article; and
f. post-heating the welded article at a second predetermined temperature.

17. The welded article according to claim 18, wherein the weld has a tensile strength at room temperature in a range from about 65% to about 85% of the strength of the aluminum alloy steel when unwelded.
